(19) United States
(12) Patent Application Publication
(10) Pub. No.: US 2002/0173346 A1
(43) Pub. Date: Nov. 21, 2002

(54) Neck Phone

(76) Inventor: Chin-Yang Wang, Taipei Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/885,950

(22) Filed: Jun. 22, 2001

(30) Foreign Application Priority Data
May 18, 2001 (TW) 90208172

(51) Int. Cl. H04M 1/00

(52) U.S. Cl. 455/568; 455/569; 455/575

(57) ABSTRACT

A neck phone comprises a hanging band, and a transmitter. The hanging band provides a shape of an open loop. The transmitter is a microphone with a connecting rod to be joined to one of two ends of the hanging band and having an electric wire with a plug fitting with a socket in a mobile phone. The receiver is a speaker connected to another end on the hanging band and has another electric wire with another plug for fitting with the socket in a mobile phone. When the hanging band is hung on the neck of a user, the user can transmit a call and receive incoming sound signal.

### BACKGROUND OF THE INVENTION

1. Field of The Invention

The present invention relates to a neck phone, and, particularly, to a hanging band with a transmitter and a receiver, which is possible to be hung on the neck of a user to perform a function of phone set.

2. Description of Related Art

A mobile phone has brought us a great convenience because it is possible for us to transmit messages wherever and whenever, that is, a phone call can be made or received without being limited by the time and the location. Hence, it is greatly helpful for a business communication or a personal conversation. This is why the mobile phone is so popularly used since it has been available in the market.

However, the mobile phone brings us certain side effect also. For instance, it is not safe that using the mobile phone during driving a car on the road so that some of the countries have legislated against the mobile phone being held for transmitting or receiving phone calls during a drive.

Accordingly, a handset free transmitter-receiver has been developed for the user to comply with the legislation. The conventional handset free transmitter-receiver provides a band as the headphone does with an end thereof having a flat earphone covering an ear and the other end thereof having a transmitter such as a microphone. Although the loudspeaker in a car can be used instead of the earphone as an output, mostly the type of the band over the head with the earphone covering the ear microphone is used much earlier and more popular.

Shortcomings of the headphone are that the band covering the head with the earphone covering the ear may disturb the hairstyle and result in an uncomfortable ear muscle. It is more serious that it may leads to a stagnation of the industrial technology once the type of headphone is kept using without any change.

### SUMMARY OF THE INVENTION

An object of the present invention is to provide a neck phone, which has a hanging band with two ends thereof to fit with the neck of a user snugly to overcome the shortcomings of the headphone.

### BRIEF DESCRIPTION OF THE DRAWINGS

The present invention can be more fully understood by referencing to the following description and accompanying drawings, in which:

FIG. 1 is a perspective view of a headphone according to the present invention; and

FIG. 2 is a perspective view illustrating the headphone in use.

### DETAILED DESCRIPTION OF THE PREFERRED EMBODIMENTS

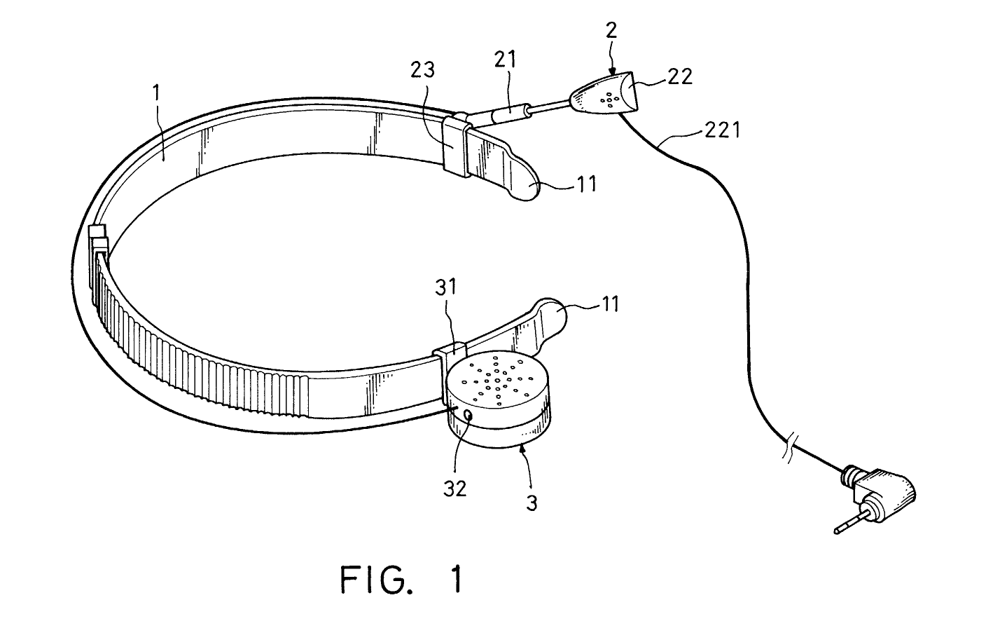

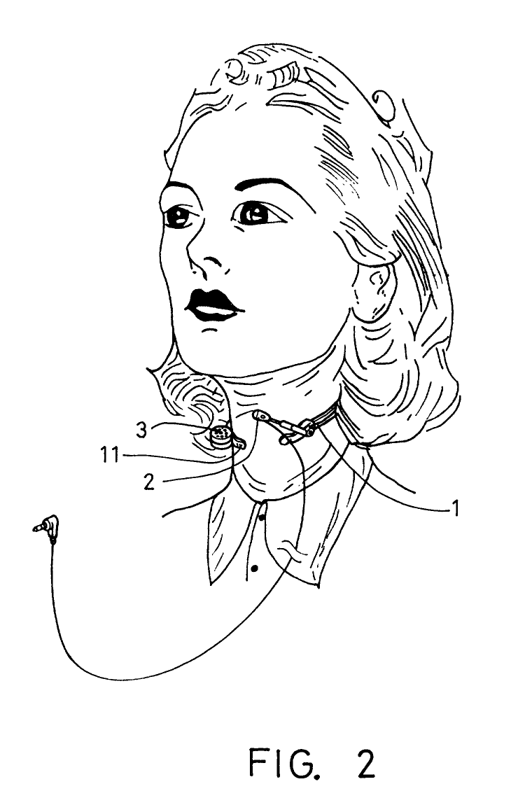

Referring to FIGS. 1 and 2, the creativeness of a neck phone according to the present invention basically resides in that the neck phone has transmitting and the receiving parts thereof properly accommodate to the mouth and the ear of a person respectively as soon as the neck phone is hung on the neck of the person. Accordingly, the neck phone of the present invention comprises a hanging band 1, a transmitter 2, and a receiver 3.

Wherein, the hanging band 1 has a shape of open loop such that it is possible to be hung on the neck as shown in FIG. 2. Further, the hanging band 1 can be designed to provide double sections as shown in FIG. 1 such that the width or the loop diameter is adjustable. It is noted that the design of double sections for the hanging band is prior art so that no detail with regard to the design will be described. In order to touch the neck snugly, both ends of the hanging band have an inward bend to constitute a touching pierce 11 respectively.

The transmitter 2 is composed of a microphone 2 with a connecting rod 21 and is attached to the hanging band 1 at an end part thereof by way of an engaging device 23. The engaging device 23 illustrated in FIG. 1 is a clip, but it is only an example not for a limitation. The connecting rod 21 can move pivotally with respect to the hanging band 1 for an angular adjustment, for instance, by way of an adjustable screw as shown in FIG. 1. The microphone 22 provides an electric wire 221 with a plug for connecting with a mobile phone. This is also belongs to prior art and no detail will be described.

The receiver 3 is a speaker and can be connected to another end part of the hanging band 1 by way of a joining device 31 movably or fixedly. The joining device 31 is a clip shown in FIG. 1, but it is only for taking an example and not a limitation. The receiver 3 also provides an electric wire with a plug for connecting with the mobile phone. In order to intensify the power and to last the output, a conventional power source can be added. In addition, the receiver 3 can provide an engaging hole 32 for connecting with an earphone wire such that a earphone can be used for receiving phone calls instead as soon as the power becomes weak. The engaging hole 32 has a required circuit therein for transmitting the sound signal.

Referring to FIGS. 1 and 2 again, as soon as the neck phone of the present invention is worn, the hanging band 1 is hung on the neck of a user such that the receiver 3 can be located next to one of the ears and the transmitter 2 can be located next to the mouth. Thus, the operation of transmitting or receiving call can be performed without any assistance of a hand conveniently. In addition, while the neck phone is used, the hairstyle cannot be disturbed as the conventional headphone does.

While the invention has been described with reference to preferred embodiments thereof, it is to be understood that modifications or variations may be easily made without departing from the spirit of this invention, which is defined in the appended claims.

What is claimed is:

1. A neck phone, comprising:
a hanging band, providing a shape of an open loop with two ends;
a transmitter, being a microphone with a connecting rod being joined to one of the ends of the hanging band, and having an electric wire with a plug fitting with a socket in a mobile phone; and
a receiver, being a speaker connected to another end of the hanging band, and having a another electric wire with another plug for fitting with the socket in a mobile phone;
whereby, when hanging band is hung on the neck of a user, the user can operate to transmit a call and receive incoming signal.

2. The neck phone according to claim 1, wherein an engaging device joins the connecting rod to the hanging band, and another engaging device joins the receiver to the hanging band.

3. The neck phone according to claim 1, wherein the connecting rod can move pivotally with respect to the hanging band.

4. The neck phone according to claim 1, wherein the receiver may provide an electrically connected socket for being inserted by an earphone.

5. The neck phone according to claim 1, wherein the receiver may be added a power source.

6. The neck phone according to claim 1, wherein the hanging band is composed of band sections with an adjustable length.

7. The neck phone according to claim 1, wherein the two ends of the hanging band may provided with a bend to constitute a touching piece respectively.
